(19) United States
(12) Patent Application Publication
(10) Pub. No.: US 2017/0060322 A1
(43) Pub. Date: Mar. 2, 2017

(54) Capacitive Touch Sensor Circuit, Method of Forming Circuit, and Touch Screen and Mobile Device Comprising the Same

(71) Applicant: NOKIA TECHNOLOGIES OY, Espoo (FI)

(72) Inventor: Long DING, Beijing (CN)

(73) Assignee: Nokia Technologies Oy, Espoo (FI)

(21) Appl. No.: 15/120,787

(22) PCT Filed: Mar. 3, 2014
(86) PCT No.: PCT/CN2014/072792

§ 371 Date: Aug. 23, 2016

(51) Int. Cl. G06F 3/041; G06F 3/044

(52) U.S. Cl. CPC G06F 3/0416; G06F 3/044; G06F 2203/04103

(57) ABSTRACT

A capacitive touch sensor circuit including a plurality of driving elements arranged as multiple rows in parallel with a horizontal axis of the touch screen, wherein the plurality of driving elements are connected into a plurality of driving lines; and a plurality of sensing elements arranged as multiple columns in parallel with a vertical axis of the touch screen, wherein the plurality of sensing elements are connected into a plurality of sensing lines, each of the plurality of sensing elements being paired with a respective one of the plurality of driving elements. The driving lines and the sensing lines are configured as at least one of: at least two driving elements of one of the plurality of driving lines being positioned at different rows; and at least two sensing elements of one of the plurality of sensing lines being positioned at different columns.

### FIELD OF THE INVENTION

Embodiments of the present disclosure relate to a touch screen and specifically to a capacitive touch sensor circuit for a touch screen, a method of forming the circuit and a touch screen and a mobile device comprising the same.

### BACKGROUND OF THE INVENTION

Capacitive touch screens, as a typical representative of touch screens, have been used in different kinds of devices. When a touch screen assembles with a display, it may form some parasitic capacitance between touch sensors consisting the touch screen and display driver sensors consisting the display screen. The display driving signal can feed through this capacitance coupling to touch screen sensor which is a noise for touch screen. When the touch screen gets closer to the display, the parasitic capacitance between the touch screen and display become larger. So does the noise.

A trend of the touch screen is to be thinner and thinner. However, as a cost, the touch screen is facing the increasing noise from a display screen such as LCD due to the reasons described above. Full lamination and On-Cell solution are examples in which the distance between a touch screen and a display is so small that the noise coupling is increased.

Conventional solutions for decreasing the noise are adding shelling layers between the touch screen and the display, which, however, disadvantageously increases the thickness of the screen. Therefore, a challenge in the field is how to decrease noise between a touch screen and a display without increasing the thickness of the touch screen.

### SUMMARY OF THE INVENTION

In order to address the foregoing and other potential problems, embodiments of the present disclosure propose a capacitive touch sensor circuit for a touch screen, a method for forming the circuit, and a touch screen and a mobile device comprising the circuit.

According to a first aspect, embodiments of the present disclosure provide a capacitive touch sensor circuit for a touch screen comprising a plurality of driving elements arranged as multiple rows in parallel with a horizontal axis of the touch screen, wherein the plurality of driving elements are connected into a plurality of driving lines; and a plurality of sensing elements arranged as multiple columns in parallel with a vertical axis of the touch screen, wherein the plurality of sensing elements are connected into a plurality of sensing lines, each of the plurality of sensing elements being paired with a respective one of the plurality of driving elements. The driving lines and the sensing lines are configured as at least one of: at least two driving elements of one of the plurality of driving lines being positioned at different rows; and at least two sensing elements of one of the plurality of sensing lines being positioned at different columns.

According to a second aspect, embodiments of the present invention provide method of forming a capacitive touch sensor circuit for a touch screen. The method comprises arranging a plurality of driving elements as multiple rows in parallel with a horizontal axis of the touch screen, wherein the plurality of driving elements are connected into a plurality of driving lines; and arranging a plurality of sensing elements as multiple columns in parallel with a vertical axis of the touch screen, wherein the plurality of sensing elements are connected into a plurality of sensing lines. The driving lines and the sensing lines are configured as at least one of: at least two driving elements of one of the plurality of driving lines being positioned at different rows; and at least two sensing elements of one of the plurality of sensing lines being positioned at different columns.

According to a third aspect, embodiments of the present invention provide a touch screen comprising a capacitive touch sensor circuit described above.

According to a fourth aspect, embodiments of the present invention provide a mobile device comprising a capacitive touch sensor circuit described above.

These and other optional embodiments of the present invention can be implemented to realize one or more of the following advantages. In accordance with some embodiments of the present disclosure, the noise between a touch screen and a display can be decreased without increasing the thickness of the screen.

### BRIEF DESCRIPTION OF THE DRAWINGS

Through the more detailed description of some preferred embodiments of the present disclosure in the accompanying drawings, the above and other objects, features and advantages of the present disclosure will become more apparent, wherein the same reference numerals generally refer to the same components in the embodiments of the present disclosure.

FIG. 1 schematically illustrates a traditional assembly of a touch screen and a display;

FIG. 2 schematically illustrates a traditional arrangement of a capacitive touch sensor circuit for a touch screen;

FIG. 3 schematically illustrates an arrangement of sensor cells of a capacitive touch sensor circuit according to an embodiment of the present disclosure;

FIG. 4 schematically illustrates another arrangement of sensor cells of a capacitive touch sensor circuit according to an embodiment of the present disclosure;

FIG. 5 schematically illustrates an arrangement of sensor cells of a capacitive touch sensor circuit according to a further embodiment of the present disclosure;

FIG. 6 schematically illustrates an arrangement of sensor cells of a capacitive touch sensor circuit according to yet a further embodiment of the present disclosure;

FIG. 7 schematically illustrates a block diagram of a mobile device 700 using the capacitive touch sensor circuit according to various embodiments of the present disclosure.

### DETAILED DESCRIPTION OF EMBODIMENTS

Some preferred embodiments will be described in more detail with reference to the accompanying drawings, in which the preferred embodiments of the present disclosure have been illustrated. However, the present disclosure can be implemented in various manners, and thus should not be construed to be limited to the embodiments disclosed herein. On the contrary, those embodiments are provided for thorough and complete understanding of the present disclosure, and completely conveying the scope of the present disclosure to those skilled in the art.

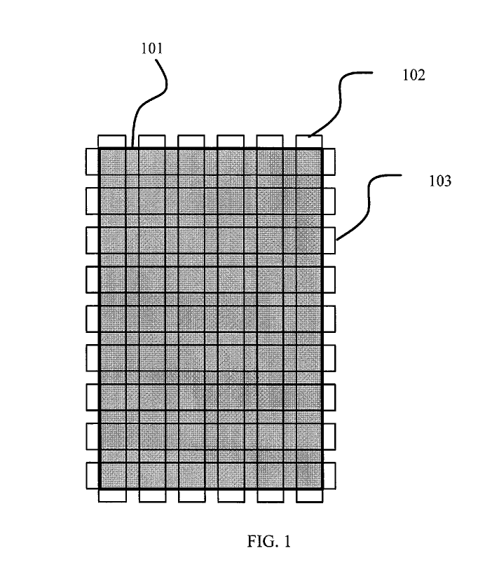

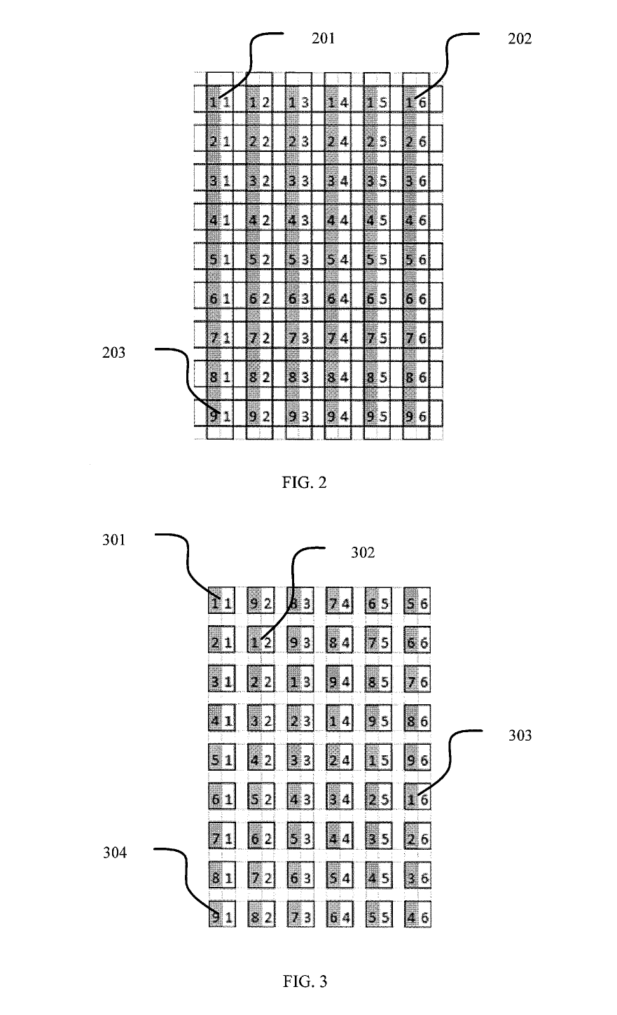

Reference is first made to FIG. 1, which schematically illustrates a traditional assembly of a touch screen and a display. As shown in FIG. 1, driving signals for a display 101 typically have specific physical directions depending on the display structure and driving method. In most cases, for example, one physical direction 103 may be in parallel with a horizontal axis of the display 101, and another physical direction 102 may be in parallel with a vertical axis of the display 101. Signals can be driven row by row in the horizontal direction and simultaneously in the vertical direction. On the other hand, a traditional capacitive touch sensor for a touch screen also has a horizontal driving direction and a vertical sensing direction. Referred to FIG. 2, for example, which schematically illustrates a traditional arrangement of a capacitive touch sensor circuit for a touch screen, the touch sensor circuit comprises a plurality of touch pixels (also referred to as sensor cells) 201, 202, 203, etc., each containing a driving element (also referred to as a transmitter, TX) and a sensing element (also referred to as a receiver, RX). For differentiating driving elements with sensing elements, driving elements are shadowed in FIG. 2, as well as FIGS. 3 to 6. Each touch pixel is encoded as (driving element, sensing element) to be identified uniquely. Take touch pixel 201 encoded as (1, 1) as an example, the driving element is 1, and the sensing element is also 1; however, for touch pixel 202 (1, 6), the driving element and the sensing element are 1 and 6 respectively. As shown in FIG. 2, driving elements are arranged as an array with multiple rows (e.g., in a direction from 201 to 202) in parallel with a horizontal axis of the touch screen, and sensing elements are arranged as an array with columns (e.g., in a direction from 201 to 203) in parallel with a vertical axis of the touch screen. In a traditional touch sensor circuit as shown in FIG. 2, driving lines are formed by connecting driving elements positioned in a same row. For example, a conductive pathway from the driving element of pixel 201 to that of pixel 202 makes a driving line. Likewise, a conductive pathway from the sensing element of pixel 201 to that of pixel 203 makes a sensing line. In an encoded array, driving lines and sensing lines may be identified from codes of touch pixels. For example, driving elements with a same code belong to a same driving line, and sensing elements with a same code belong to a same sensing line. As a result, the noise between a traditional touch screen and a display might be large due to the same driving direction thereof.

To decrease the noise, reference is now made to FIG. 3, which schematically illustrates an arrangement of sensor cells of a capacitive touch sensor circuit according to an embodiment of the present disclosure. As shown in FIG. 3, the touch sensor circuit comprises a plurality of driving elements arranged as multiple rows in parallel with a horizontal axis of the touch screen, and a plurality of sensing elements arranged as multiple columns in parallel with a vertical axis of the touch screen. Each of the plurality of sensing elements is paired with a respective one of the plurality of driving elements. A touch pixel such as 301, for example, shows a pair of a driving element and a sensing element (1, 1). As an example, driving elements in the first row as shown in FIG. 3 are encoded as 1, 9, 8, 7, 6, 5, respectively; and sensing elements in the first column are encoded as 1, 2, 3, 4, 5, 6, 7, 8, 9, respectively. It should be noted that terms of “row” and “column” are only for purpose of distinguishing between each other, and are interchangeable in name. That is, the direction of pixel (1, 1) to (5, 6) as shown in FIG. 3, although called as a row hereinafter, may also be taken as a column in other instances; and the direction of pixel 301 to 304 may be taken as a row then. The present disclosure is not limited in this regard.

To decrease noise between the touch screen and the display, one solution according to embodiments of the present disclosure may be that the plurality of driving elements are connected into a plurality of driving lines so that at least two driving elements of one of the plurality of driving lines are positioned at different rows. For example, as shown in FIG. 3, a driving line may be formed by connecting driving element of pixel 301 to that of pixel 302 in another row. In a preferred implementation, at least one of the driving lines is linear, e.g, from pixel 301, through pixel 302, to pixel 303. Therefore, pixels 201 to 202, for example, as shown in FIG. 2 is rearranged as 301 to 303 as shown in FIG. 3, in a tilt manner. In this way, there is only one touch pixel in each row which may be interfered by the display ((1, 1) for the first row, (2, 1) for the second row, . . . , etc.); thus for driving elements arranged as m rows, the coupling area of this direction (row) decreases to 1/m comparing to what is m in traditional design, so does the noise.

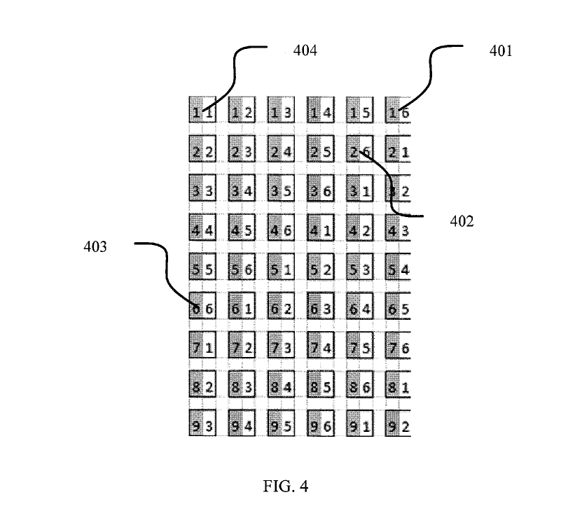

As an alternative, the plurality of sensing elements may also be connected into a plurality of sensing lines so that at least two sensing elements of one of the plurality of sensing lines are positioned at different columns. Referred now to FIG. 4, which schematically illustrates another arrangement of sensor cells of a capacitive touch sensor circuit according to an embodiment of the present disclosure, a sensing line may be formed by connecting sensing element of pixel 401, to that of pixel 402 in another column, down to that of pixel 403 in a further column. In a preferred implementation, at least one of the sensing lines is linear (not shown in FIG. 4). Compared to 201 to 202 as shown in FIG. 2, the code cells (1, 6), (2, 6) . . . (6, 6) are rearranged in a tilt direction (i.e., 401 to 403) in FIG. 4. Similar to FIG. 3, there is only one touch pixel in each column which may be interfered by the display ((1, 1) for the first column, (1, 2) for the second column, . . . , etc.); thus for sensing elements arranged as n columns, the coupling area of this direction (column) decreases to 1/n comparing to what is n in traditional design, so does the noise.

It should also be noted that the solutions as stated with respect to FIGS. 3 and 4 may be combined. That is, at least two driving elements of one of the plurality of driving lines are positioned at different rows; and at least two sensing elements of one of the plurality of sensing lines are positioned at different columns, so that the circuit pattern of the touch screen may be broken to be more irregular to further decrease noise.

In practice, it is more meaningful to consider noise occurred in a touch area that a user's finger usually covers in touching. To minimize noise within a touch area, driving lines may be configured so that driving elements positioned in a row within the touch area each belongs to a different driving line.

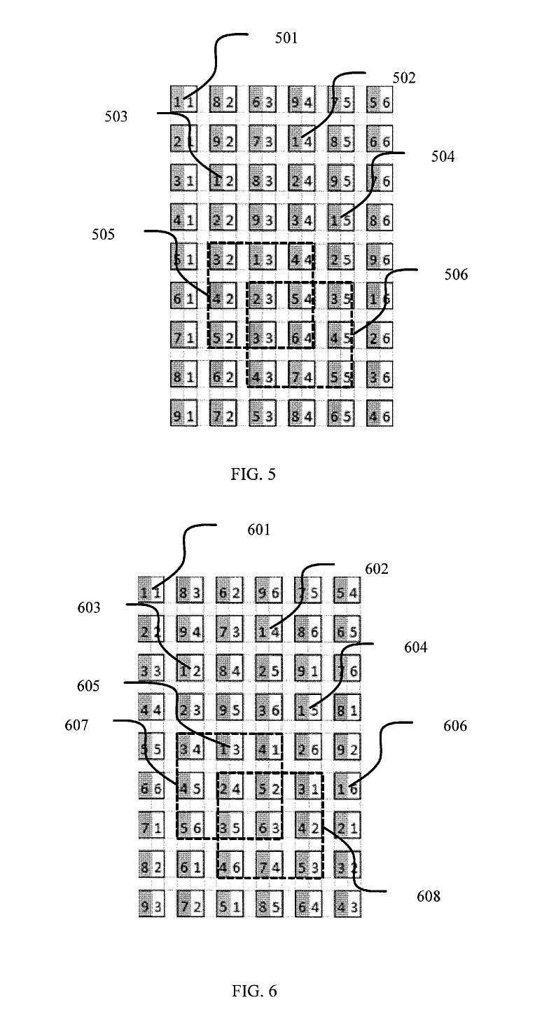

Reference is now made to FIG. 5, which schematically illustrates an arrangement of sensor cells of a capacitive touch sensor circuit according to a further embodiment of the present disclosure. As shown in FIG. 5, the sensor cells (1, 1), (1, 4), (1, 2), (1, 5) (i.e., 501 to 504) have a period 3 in the horizontal direction and a period 2 in the vertical direction. So do all other sensor cells. Take a 3*3 touch pixels as a touch area, for example. For a touch area 505, each of driving elements (3, 2), (1, 3), (4, 4) positioned in the first row within the touch area belongs to a different driving line. Similarly, for a touch area 506, each of driving elements (2, 3), (5, 4), (3, 5) positioned in the first row within the touch area belongs to a different driving line. By this arrangement, the repeat m in (m, n) is below 2 so that the coupling area decreased ⅓ in this area compared to what are 3 in traditional design. Those skilled in the art should understand that a touch area of 3*3 touch pixels are only an example for purpose of illustration, and other size of touch area is also applicable for the solution.

Likewise, sensing lines may also be configured so that each of sensing elements positioned in a column within the touch area belongs to a different sensing line to minimize noise within a touch area.

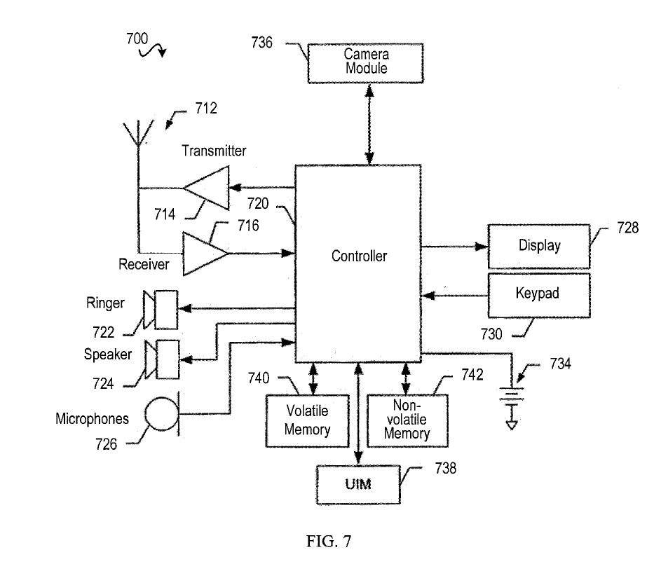

Reference is now made to FIG. 6, which schematically illustrates an arrangement of sensor cells of a capacitive touch sensor circuit according to yet a further embodiment of the present disclosure. As shown in FIG. 6, not only the sensor cells (1, 1), (1, 4), (1, 2), (1, 5) (i.e., 601 to 604) have a period 3 in the horizontal direction and a period 2 in the vertical direction similar to FIG. 5, but also pixels (m, 1), (m, 2) . . . is rearranged irregularly. As showed in touch areas 607 and 608, the repeat m and n in (m, n) are below 2. Thus for a touch area 607, not only each of driving elements (3, 4), (1, 3), (4, 1) positioned in the first row within the touch area belongs to a different driving line, but also each of sensing elements (3, 4), (4, 5), (5, 6) positioned in the first column within the touch area belongs to a different sensing line. Similarly, for a touch area 608, not only each of driving elements (2, 4), (5, 2), (3, 1) positioned in the first row within the touch area belongs to a different driving line, but also each of sensing elements (2, 4), (3, 5), (4, 6) positioned in the first column within the touch area belongs to a different sensing line. By this arrangement, the repeat m and n in (m, n) are both below 2.

Those skilled in the art should appreciate that although solutions as presented in FIG. 6 is illustrated on the basis of solution described with respect to FIG. 5, it may be performed independent of solution described with respect to FIG. 5. That is, the driving lines and the sensing lines may be configured independently with each other.

According to embodiments of the present disclosure, each of the plurality of driving elements belongs to a driving line, and belongs to an exact one driving line; and each of the plurality of sensing elements belongs to a sensing line, and belongs to an exact one sensing line. In another word, each touch pixel as shown in FIGS. 3 to 6 is encoded uniquely.

It should be noted that the illustrations presented with respect to FIGS. 3 to 6 are examples only, and do not intended to restrict the present disclosure in this regard. That is, the present disclosure is not limited to any specific pattern breaking solution in this regard.

By means of implementing an irregular pattern design, the coupling area for specific direction or area between a touch screen and a display is decreased. As coupling area decreases, the efficient capacitance decreases, so that the coupling noise decreases.

Embodiments herein according to present disclosure also provide a method of forming a capacitive touch sensor circuit for a touch screen. The method comprises forming a plurality of driving elements as multiple rows in parallel with a horizontal axis of the touch screen; forming a plurality of sensing elements as multiple columns in parallel with a vertical axis of the touch screen; and forming a plurality of driving lines and a plurality of sensing lines, wherein the plurality of driving elements are connected into a plurality of driving lines, and wherein the plurality of sensing elements are connected into a plurality of sensing lines. Moreover, the driving lines and the sensing lines are configured as at least one of: at least two driving elements of one of the plurality of driving lines being positioned at different rows; and at least two sensing elements of one of the plurality of sensing lines being positioned at different columns.

In an implementation, at least one of the driving lines is linear; or at least one of the sensing lines is linear, or both.

In an implementation, the method further comprises configuring the driving lines so that, with respect to a touch area, each of driving elements positioned in a row within the touch area belongs to a different driving line; or comprises configuring the sensing lines so that, with respect to a touch area, each of sensing elements positioned in a column within the touch area belongs to a different sensing line, or both.

In an implementation, each of the plurality of driving elements belongs to an exact one driving line, and each of the plurality of sensing elements belongs to an exact one sensing line.

Embodiments herein according to present disclosure also provide touch screen comprising a capacitive touch sensor circuit as described above.

FIG. 7 schematically illustrates a block diagram of a mobile device 700 using a capacitive touch sensor circuit according to embodiments herein. The mobile device 700 may be provided with a wireless communication capability. However, it should be understood that it is merely exemplary and non-limiting. Other types of user devices may also easily adopt embodiments of the present invention, such as a portable digital assistant (PDA), a pager, a mobile computer, a mobile TV, a game apparatus, a laptop, a camera, a video camera, a GPS device, and other types of voice and textual communication system. A fixed-type user device may likewise easily use embodiments of the present invention.

The device 700 comprises one or more antennas 712 operable to communicate with the transmitter 714 and the receiver 716. The device 700 further comprises at least one processor controller 720. It should be understood that the controller 720 comprises a circuit required for implementing the function of the mobile terminal 700. For example, the controller 720 may comprise a digital signal processor device, a microprocessor device, an A/D converter, a D/A converter, and other support circuits. The control and signal processing functions of the device 700 are allocated in accordance with respective capabilities of these devices. The device 700 may further comprise a user interface, which, for example, may comprise a ringer 722, a speaker 724, a microphone 726, a display 728, and an input interface, and all of the above devices are coupled to the controller 720. Specially, input interface may include, among other things, a keypad 730 according to embodiments of the present invention as detailed above.

The device 700 may further comprise a camera module 736 for capturing static and/or dynamic images. The device 700 further comprises a battery 734, such as a vibrating battery set, for supplying power to various circuits required for operating the mobile terminal 700 and alternatively providing mechanical vibration as detectable output. The device 700 may further comprise a user identification module (UIM) 738. The UIM 738 is usually a memory device with a processor built in. The UIM 738 may for example comprise a subscriber identification module (SIM), a universal integrated circuit card (UICC), a universal user identification module (USIM), or a removable user identification module (R-UIM), etc. The UIM 738 may comprise a card connection detecting apparatus according to embodiments of the present invention.

The device 700 further comprises a memory. For example, the device 700 may comprise a volatile memory 740, for example, comprising a volatile random access memory (RAM) in a cache area for temporarily storing data. The device 700 may further comprise other non-volatile memory 742 which may be embedded and/or movable. The non-volatile memory 742 may additionally or alternatively include for example, EEPROM and flash memory, etc. The memory may store any item in the plurality of information segments and data used by the device 700 so as to implement the functions of the device 700.

The several exemplary embodiments of the present invention have been described above just for the purpose of illustration. It should be understood that the present invention is not limited to the disclosed embodiments. On the contrary, the present invention intends to cover various modifications and equivalent arrangements included in the spirit and scope of the appended claims. The scope of the appended claims meets the broadest explanations and covers all such modifications and equivalent structures and functions.

1. A capacitive touch sensor circuit for a touch screen comprising:
a plurality of driving elements arranged as multiple rows in parallel with a horizontal axis of the touch screen, wherein the plurality of driving elements are connected into a plurality of driving lines; and
a plurality of sensing elements arranged as multiple columns in parallel with a vertical axis of the touch screen, wherein the plurality of sensing elements are connected into a plurality of sensing lines, each of the plurality of sensing elements being paired with a respective one of the plurality of driving elements,
wherein the driving lines and the sensing lines are configured as at least one of: at least two driving elements of one of the plurality of driving lines being positioned at different rows; and
at least two sensing elements of one of the plurality of sensing lines being positioned at different columns.

2. The capacitive touch sensor circuit of claim 1, wherein at least one of the driving lines is linear.

3. The capacitive touch sensor circuit of claim 1, wherein at least one of the sensing lines is linear.

4. The capacitive touch sensor circuit of claim 1, wherein the driving lines are configured so that, with respect to a touch area, each of driving elements positioned in a row within the touch area belongs to a different driving line.

5. The capacitive touch sensor circuit of claim 1, wherein the sensing lines are configured so that, with respect to a touch area, each of sensing elements positioned in a column within the touch area belongs to a different sensing line.

6. The capacitive touch sensor circuit of claim 1, wherein each of the plurality of driving elements belongs to an exact one driving line, and each of the plurality of sensing elements belongs to an exact one sensing line.

7. A method of forming a capacitive touch sensor circuit for a touch screen comprising:
forming a plurality of driving elements as multiple rows in parallel with a horizontal axis of the touch screen;
forming a plurality of sensing elements as multiple columns in parallel with a vertical axis of the touch screen; and
forming a plurality of driving lines and a plurality of sensing lines, wherein the plurality of driving elements are connected into a plurality of driving lines, and wherein the plurality of sensing elements are connected into a plurality of sensing lines,
wherein the driving lines and the sensing lines are configured as at least one of: at least two driving elements of one of the plurality of driving lines being positioned at different rows; and
at least two sensing elements of one of the plurality of sensing lines being positioned at different columns.

8. The method of claim 7, wherein at least one of the driving lines is linear.

9. The method of claim 7, wherein at least one of the sensing lines is linear.

10. The method of claim 7, further comprising configuring the driving lines so that, with respect to a touch area, each of driving elements positioned in a row within the touch area belongs to a different driving line.

11. The method of claim 7, further comprising configuring the sensing lines so that, with respect to a touch area, each of sensing elements positioned in a column within the touch area belongs to a different sensing line.

12. The method of any of claim 7, wherein each of the plurality of driving elements belongs to an exact one driving line, and each of the plurality of sensing elements belongs to an exact one sensing line.

13. A touch screen comprising a capacitive touch sensor circuit according to claim 1.

14. A mobile device comprising a capacitive touch sensor circuit according to claim 1.
